(19) United States
(12) Patent Application Publication
(10) Pub. No.: US 2019/0062994 A1
(43) Pub. Date: Feb. 28, 2019

(54) PROCESS FOR SPLICING COVERBRAIDED ROPES HAVING AT LEAST ONE EYE

(71) Applicant: HAMPIDJAN HF, Reykjavik (IS)

(72) Inventor: Sherif Safwat, Sainbridge Island, WA (US)

(73) Assignee: HAMPIDJAN HF, Reykjavik (IS)

(21) Appl. No.: 15/766,814

(22) PCT Filed: Nov. 7, 2016
(86) PCT No.: PCT/IS2016/050019

§ 371 Date: Apr. 8, 2018

Related U.S. Application Data
(60) Provisional application No. 62/251,653, filed on Nov. 5, 2015.

(51) Int. Cl. D07B 1/18; D04C 1/12; D07B 5/00; D07B 7/16; B65H 69/06

(52) U.S. Cl. CPC D07B 1/185; D04C 1/12; D07B 5/005; D07B 7/165; D07B 7/169; A01K 75/00; D07B 2201/1096; D07B 2201/2086; D07B 2201/209; D07B 2501/2038; D07B 2501/2061; B65H 69/06

(57) ABSTRACT

Methods are provided for forming spliced connections in coverbraided ropes in the form of a sling having at least one eye. The methods include the step of situating a void spacer adjacent to a portion of a core rope. The methods also include coverbraiding the removable void spacer to create a tunnel into which a section of the same coverbraided sheath enclosing a strength member core is able to be positioned in between the strength member core and the coverbraided sheath enclosing the strength member core in the vicinity of the spliced eye's splice braid zone, thereby forming a spliced eye connection.

### TECHNICAL FIELD

The present disclosure relates to ropes and more particularly to coverbraided ropes and especially to methods for forming spliced connections in coverbraided ropes. Coverbraided ropes and also known as “overbraided rope” and are formed from a strength member core surrounded by a braided sheath wherein the braided sheath is formed of several strands. In some embodiments, one or more of the strands forming the braided sheath is significantly larger than the other strands so as to form a series of cambered sections capable of either or both causing lift and reducing drag when such rope is subjected to water flow about the rope in a position that corresponds to a position assumed by ropes used in forming pelagic trawl mesh in pelagic trawls.

### BACKGROUND ART

Tightly coverbraided ropes are well known as the most easy to handle, most abrasion resistant and least likely to tangle rope type for many applications. These applications include but are not limited to synthetic warps and towlines, synthetic trawler warps, yachting lines, anchoring lines, deep water mooring lines, deep water oil derrick anchoring lines, seismic lines, paravane and superwide lines, rigging lines, ropes for forming pelagic mesh in pelagic trawls and many other.

Tightly coverbraided ropes also have other benefits including safety when used around persons. For example, a tightly coverbraided rope when properly made usually is able to be easily visually inspected to ascertain that the coverbraided sheath protecting the strength member has not failed and thus the rope should be safe to use.

In the commercial pelagic trawl fishing industry, tightly coverbraided ropes exhibit far superior stiffness and resistance to tangling than any other type of rope. For this reason, they are highly favored for certain portions of pelagic trawl's, especially the pelagic mesh (i.e. mesh having greater than four meters in mesh size) used in forming the trawl's front part top and side portions, and often used in forming the front part bottom portion as well. A self-spreading coverbraided rope known as “Helix rope”, used in trawls sold by Hampidjan HF of Iceland are one form of coverbraided rope that are both easy to handle and also can be used to maintain open a trawl net, increasing catch efficiency, improving selective fishing and preventing marine mammal drowning.

In use in anchoring lines and mooring lines of all types, and in towing lines including superwides, trawler warps and towing warps of all kinds, and wherever it is desired to substitute steel cable, chain or other ropes with a lighter, long lasting and durable synthetic rope, a rope Manufactured by Hampidjan HF of Iceland and known as Dynice Dux is increasing in popularity among certain customer bases. A problem in using this rope is that, as is the problem with all other tightly coverbraided ropes, the coverbraid is extremely difficult to include into a splice braid zone and to harness most of its strength in the rope. Thus, because the coverbraid is formed of a considerable proportion of the rope's material, the expense incurred in forming the coverbraid is not recovered in the useful strength of the rope, increasing its cost and slowing its acceptance. As one of the benefits of such a rope is greatly increased safety compared to steel wire or in some cases chain, especially because when the steel wire or chain breaks it is known to be crippling and even fatal to nearby personnel, whereas a Dynice Dux is essentially harmless in the same situation, it is important to increase the use of such rope in place of these more dangerous alternatives.

It is very difficult to splice tightly coverbraided (herein including “overbraided”) ropes. This is due to the fact that good quality coverbraided ropes have very tight covers (i.e. “braided sheaths”). That is, the braided sheaths are very tightly braided around a core that itself is a strength member. Due to the tightness of the braiding it is not economically feasible to separate the sheath from the core a sufficient amount needed to permit passing a terminal end of the rope through the cover and especially through the core, as is needed to form a maximally strong splice, without weakening or breaking the braided sheath.

To overcome these difficulties in the commercial pelagic trawl net industry, for several years some net makers have resorted to clamping the coverbraided ropes used to form pelagic trawl mesh. However, the clamps pose other problems such as excessive wear of the trawls when the relatively hard clamp abrades the relatively softer rope. Furthermore, clamps often much reduce the longevity of a rope, i.e. the strength retention over time. Users of coverbraided ropes as towing warps, seismic lines, yachting lines and anchoring lines of all types have resorted to discarding a portion of the coverbraid in the vicinity of any splice braid zone where an eye is formed and merely forming a splice in the strength member without including the coverbraid.

Consequently, due to the above problems in the art, coverbraided ropes are expensive compared to the strength harnessed from the material used in forming them. When the coverbraided rope is subjected to water flow about itself, the additional bulk caused by the coverbraid without a concurrent efficacious harness of strength from the material forming the coverbraid means a high and wasteful drag in water. However, the coverbraid is necessary for the reasons described supra. That is, it is not a good alternative to use a rope without a protective and stiffening coverbraid for the applications described supra, such as warps, towlines, trawler warps, superwide and paravane lines, seismic lines, anchoring lines, deep water oil derrick anchoring lines, yachting ropes, ropes for pelagic trawl mesh and many others. Thus, where the drag in water of the bulky coverbraid is problematic, end users are forced to use steel wire or chain. As mentioned supra, steel wire or chain themselves have the disadvantage of being unsafe, as well as other disadvantages including requiring larger and more expensive support structures when steel wire or chain is used in many applications including but not limited to deep water oil derrick mooring applications, yachting applications, trawling applications, towing warp including trawling warp applications, seismic applications and other. In trawling applications, helix ropes in particular have some disadvantages associated with their relatively high cost, much of which is due to the failure to more fully utilized potential tensile strength from the material forming the coverbraid. In the case of helix ropes, because one of these other advantages is that helix ropes are the most environmentally friendly rope for use in forming a pelagic trawl net, and permit forming a most environmentally friendly trawl net that minimizes incidental catch and does not collapse and drown marine mammals, it is a great loss to fishery resources and marine mammal conservation that helix ropes have lost favor among some pelagic trawl fishermen.

Among users of other types of coverbraided ropes, concern exists that as the coverbraid cannot be truly included in a splice in such a fashion that it contributes to the strength of the rope's terminal connections, that the ropes are rather expensive compared to the strength provided. Consequently, the use of less safe but less expensive alternatives continues to plague the workforce in many industries.

WO 2011/009929 teaches methods for splicing coverbraided rope where such methods provide for greater strength than knotted coverbraided ropes. However, one hundred percent of rope tensile strength has still not been achieved in the splice strength, thus there is a significant materials expense that is not contributing to rope breaking strength even with the taught methods.

Thus, it can readily be appreciated that a long felt need exists in the industry for a construction and method that permits splicing coverbraided ropes and especially tightly coverbraided ropes in such a way that the spliced rope retains more strength than known methods for splicing and/or knotting a variant of such rope.

### Definitions

“Core Rope”: means a portion of rope, twine, other cordage or other flexible strength member, or even a rigid strength member, that is intended to be enclosed within a sheath or other protective layer, or that already is enclosed within a sheath or other protective layer.

“Sling”: means a portion of rope, twine, other cordage, or flexible or rigid strength member having an eye at each end, or having at least one eye at one end, such as having an eye at one or both ends.

### DISCLOSURE

It is an object of the present disclosure to provide a method for splicing coverbraided ropes including all types of synthetic and mainly synthetic towing warps, trawling warps, superwides and paravane lines, seismic lines, anchoring lines of all types, yachting ropes, rigging ropes, deep water oil derrick and other oil derrick anchoring and mooring lines, ropes for forming pelagic trawl mesh and/or other portions of a trawl system such as bridles, sweeps, sweep lines, and other, helix ropes and other where such method provides for greater strength than knotted coverbraided ropes including than knotted helix ropes.

It is another object of the present disclosure to provide a method for splicing coverbraided ropes including all the types of synthetic and mainly synthetic ropes and lines mentioned supra where such method provides for reduced wear and greater longevity than knotted coverbraided ropes including than knotted helix ropes.

Disclosed is a method for forming a strong spliced eye connection in coverbraided ropes including in tightly coverbraided ropes including all the types of synthetic and mainly synthetic ropes and lines mentioned supra where a removable void spacer (i.e. an object, and preferably an elongate object, and preferably an elongate object as taught in some further detail below) is used to create a tunnel into which a section of the same coverbraided sheath enclosing a strength member core but formed without the strength member core rope inside of it (i.e. formed as a hollow braided sheath) is able to be first passed through at least one eye formed into at least one end of the strength member core, then subsequently attached to an end of the removable void spacer most proximal the open eye, then, by virtue of removing the removable void spacer such as by withdrawing it with a pneumatic ram, the portion of hollow braided sheath is positioned into a space that is either between the strength member core and at least a portion of the coverbraided sheath surrounding the strength member core, or that is between strands and/or filaments of the strength member core and thus by extension also internal at least a portion of the coverbraided sheath surrounding the strength member core. The present disclosure's method teaches a process and construction for attaching and drawing in the hollow braided sheath, and a resulting sling construction. The present disclosures process and resultant coverbraided sling teaches a coverbraided sling that provides for more breaking strength for a particular coverbraided rope having an eye at one or both ends that is provided by known methods for forming coverbraided rope slings, thereby accomplishing the objects of the present disclosure.

The spliced tightly coverbraided rope of the present disclosure harnesses most of the strength of the coverbraid in the ultimate break strength of the rope sling. Therefore, the diameter of a rope needed for any application is reduced, thereby reducing costs of the rope, reducing drag in water and thus costs to use the rope including fuel consumption costs in towing applications. Possessing the preceding advantages, the method and process for forming spliced coverbraided ropes of the present disclosure answers needs long felt in the industry.

These and other features, objects and advantages are likely to be understood or apparent to those of ordinary skill in the art from the following detailed description of the preferred embodiment:

### BRIEF DESCRIPTION OF THE DRAWING

FIG. 1 is a flow chart teaching a production method of the present disclosure for forming slings of the present disclosure.

### BEST MODE FOR CARRYING OUT THE DISCLOSURE

The present disclosure teaches a method where:

1) a spacer, that is an object, and preferably an elongate object is positioned alongside a portion of a core rope intended for use as a core for a tightly coverbraided rope (especially positioned in the vicinity of a splice braid zone of the core rope [i.e. where the splice braid or splice tuck, or other splice structure exists that is used in forming an eye into an end of the core rope], or where a splice is intended to exist for either an eye that is intended to be formed at such end of the core rope or for where it is intended to position the hollow cover that is pulled under the braided sheath). The spacer can also be positioned alongside a portion of the core rope by being inserted into the core rope (in which embodiment the elongate object may be passed through the body of the core rope several times at the splice braid zone or at an intended splice braid zone, or alternatively at least one time and left buried within and, preferably, lying coaxial with the long dimension of the core rope, the core rope preferably having a hollow braid construction), and;

2) subsequently a cover is tightly braided around both the core rope as well as the elongated object, and more particularly around at least a portion of both terminal ends of the elongate object, so that a portion of the elongate object is accessible after braiding the cover, in such a fashion as to form a tightly coverbraided rope.

3) Next:

Then, the in between open eyes portion of the sling formed of a core rope having the removable void spacer coupled to itself is coverbraided using a braiding machine that can be paused and restarted at the will of an operator. As any eye approaches the braid point, the operator pauses the machine, withdraws the eye from the interior zone of the converging braid strands, retains the eye without such interior zone of converging braid strands and re starts the braiding machine. As the eye has been withdrawn from the interior zone of the converging braid strands, the converging braid strands subsequently form a hollow braided sheath lacking the core rope interior the hollow braided sheath. As taught supra, as readily appreciated by those skilled in the art, the term “hollow braided sheath” hereinafter includes the hollow braided sheath formed of the braid strands (i.e. the strands that form the braided sheath enclosing the core rope) but lacking the core rope interior itself, even though it may include other objects interior itself, such as a thin twine to aid in manufacturing purposes by connecting together various slings formed of various distinct portions of core rope when enacting a continuous flow production method as taught herein and below. The sheath forming the coverbraid thus is formed lacking the core rope, and is optionally referred to herein as a hollow braided sheath. Then, the hollow braided sheath is made slack, such as by reversing the take up wheel of the braiding apparatus, for which it is needed to have a braiding apparatus that has a take up wheel that can be reversed. Next, a predetermined length of the slackened hollow braided sheath is passed through its corresponding open eye, bent back upon itself and attached to the proximal end of the removable void spacer (which is that terminal end of the spacer nearest/most proximal the recently withdrawn eye) and there retained by mechanical means or by hand. Then, using mechanical means such as pneumatic or hydraulic retractable ram, or by hand, the removable void spacer is withdrawn (removed) from the portion of coverbraided sheath enclosing it and in a direction that draws at least portions of the attached hollow braided sheath into the braided sheath encompassing the core rope and/or into both the braided sheath encompassing the core rope as well as the core rope itself, depending upon what position was selected for coupling the void spacer to the core rope, so that as a result the hollow braided sheath is doubled over itself and pulled as in a “hairpin” shape, or a “bent double” shape, into a space in between the core rope and the braided sheath, and or interior the braided sheath as well as interior at least portions of the core rope, and thus comes to occupy a space within the braided sheath that encompasses (including “encloses”) the core rope that previously was occupied by the removable void spacer (i.e. the “object” or “elongate object”).

Next, the length of hollow braided sheath is severed, preferably where it protrudes from the braided sheath (i.e. the sheath encompassing the core rope).

In one of the present disclosure's preferred embodiments, the elongated object is a hollow steel pipe with a steel wire formed loop at one end and a steel eye at the other end, that may be a single chain link welded to the steel pipe. In another embodiment it is a portion of twine or thin rope that is preferably formed as a loop.

The removable, elongated object, that is the “spacer”, is also known herein as a “removable void spacer” or as a “void spacer”, these terms being interchangeable.

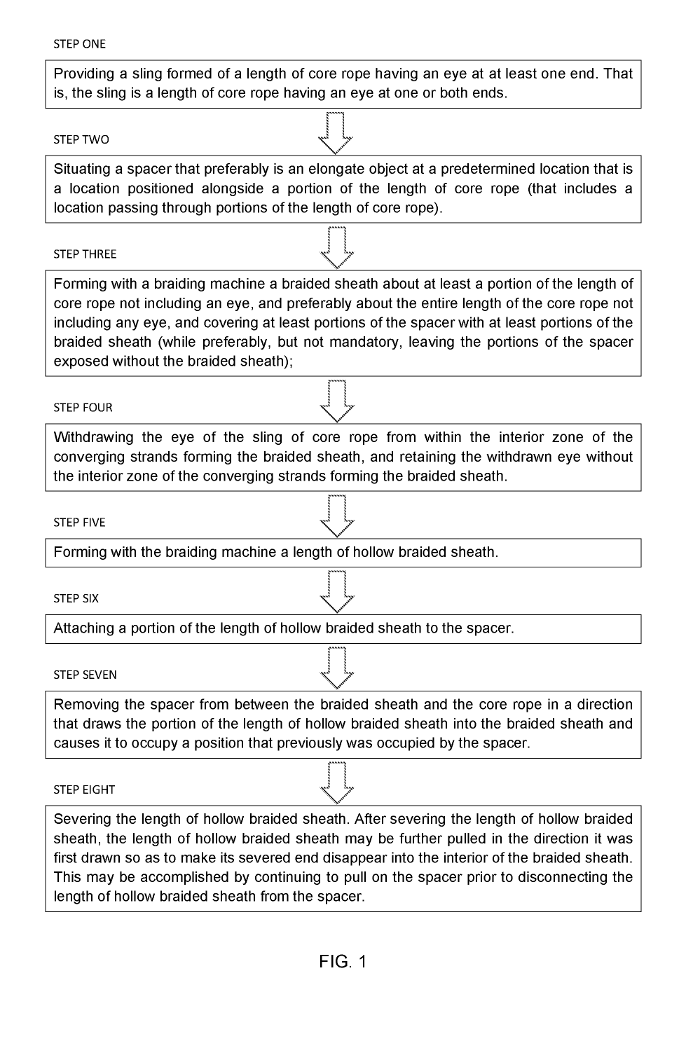

With reference to FIG. 1:

FIG. 1 is a flow chart teaching the preferred production method of the present disclosure for forming an individual sling of the present disclosure. FIG. 1 teaches the following steps:
Step One: providing a sling formed of a length of core rope and having an eye at one or both ends. That is, the sling is a length of core rope having at least one eye, and can have an eye at one or both ends;
Step Two: situating a spacer, that preferably is an elongate object, alongside a portion of the length of core rope;
Step Three: forming with a braiding machine a braided sheath about at least portions of the length of core rope, and preferably about all the portions of the length of core rope not including an eye, and covering at least portions of the spacer with at least portions of the braided sheath;
Step Four: as an eye of the core rope sling approaches the braid point, retaining the eye exterior the interior zone of the converging braid strands forming the braided sheath;
Step Five: forming with the braiding machine a length of hollow braided sheath;
Step Six: attaching a portion of the length of hollow braided sheath to the spacer;
Step Seven: removing the spacer from between the braided sheath and the core rope in a direction that draws the portion of the length of hollow braided sheath into the braided sheath enclosing the portion of core rope and causes it to occupy a position that previously was occupied by the spacer;
Step Eight: severing the length of hollow braided sheath. After severing the length of hollow braided sheath, the length of hollow braided sheath may be further pulled in the direction it was first drawn so as to make its severed end disappear into the interior of the braided sheath. This is accomplished by continuing to pull on the spacer prior to disconnecting the length of hollow braided sheath from the spacer. Otherwise, it is understood that the length of hollow braided sheath must be disconnected from the spacer, either by being released, as may be accomplished by removing a tap or mechanical fastener used to attached the length of hollow sheath to spacer, or by the spacer having a releasable wire or other loop to which was attached the length of hollow braided sheath, or by the length of hollow braided sheath being cut so the spacer's relevant portion becomes free of the length of hollow braided sheath.
Again with Reference to FIG. 1, and in Greater Detail:
Step One: providing a sling formed of a length of core rope and having an eye at one or both ends. That is, the sling is a length of core rope having at least one eye, and can have an eye at one or both ends;
Step Two: situating a spacer, that preferably is an elongate object, alongside a portion of the length of core rope. In some embodiments, the selected portion of the length of core rope is a portion internal the length of core rope, i.e. is a location passing through portions of the length of core rope.
(Most preferably, the spacer is situated at or adjacent the throat of the eye, when there is one eye, or is situated adjacent the throat of one of the eyes, when there are two eyes. The “throat” is that portion of core rope nearest the open eye and having a splice braid).
Step Three: forming with a braiding machine a braided sheath about at least portions of the length of core rope, and preferably about all the portions of the length of core rope not including an eye, and covering at least portions of the spacer with at least portions of the braided sheath, while, preferably, leaving the ends of the spacer exposed without the braided sheath, so as to permit easily enacting future steps (as is readily understood and known by one skilled in the art: a traditional braiding machine includes, but is not limited to, preferably, bobbins loaded onto cars that travel in serpentine intersecting paths in opposite directions orbiting the central axis of the braiding machine, with half the cars travelling clockwise and the other half of the cars travelling counterclockwise; the bobbins are loaded with one or more strands per bobbin [the strands can be termed “twine, cord, or other” ]; the strands feed out from the bobbins and converge upon one another at the braid point; the core rope is fed through the braiding machine, and, as a result, has the braided sheath formed about it, in what is termed a “coverbraid” or an “overbraid”, the terms being interchangeable, with the portions of the core rope not yet reaching the braid point uncovered by the braided sheath, and with those portions of the core rope having already passed the braid point enclosed by the braided sheath);
Step Four: as an eye of the core rope sling approaches the braid point, retaining the eye exterior the interior zone of the converging braid strands forming the braided sheath. Preferably, this step further includes first withdrawing the eye from within the interior zone of converging strands forming the braided sheath; and the subsequently retaining the withdrawn eye without the interior zone of the converging braid strands;
Step Five: with the withdrawn eye retained without the interior zone of the converging braid strands (see Step Four), forming with the braiding machine a length of hollow braided sheath while not enclosing either the withdrawn eye or any portion of the length of core rope within the hollow braided sheath, as is accomplished by virtue of the fact that the eye is exterior the interior zone of the converging braid strands, and is thus not able to be coverbraided by the converging braid strands, and also by virtue of the fact that because the core rope is no longer present within the interior zone of the converging braid strands, due to the fact that the withdrawn eye is the terminal portion of the core rope sling, that also the braided sheath is formed lacking the core rope.) This can also be stated as “forming with the braiding machine a length of braided sheath lacking the core rope”; and also can be stated as “forming with the braiding machine a length of hollow braided sheath” such a length of the braided sheath also appropriately known as a “length of hollow braided sheath”.
Step Six: attaching a portion of the length of hollow braided sheath to the spacer. This is preferably accomplished by first slacking the length of hollow braided sheath, than attaching it to the proximal portion of the spacer at a point that is about midpoint of the length of the hollow braided sheath.
Step Seven: removing the spacer from between the braided sheath and the core rope in a direction that draws the portion of the length of hollow braided sheath into the braided sheath and causes it to occupy a position that previously was occupied by the spacer. This also may be phrased as “withdrawing” the spacer from the braided sheath in a direction so as to draw the portion of the length of hollow braided sheath attached to the spacer into the braided sheath thereby causing it to occupy a position that previously was occupied by the spacer (or causing at least a portion of the length of hollow braided sheath attached to the spacer to occupy a position that previously was occupied by at least a portion of the spacer;
Step Eight: severing the length of hollow braided sheath. After severing the length of hollow braided sheath, the length of hollow braided sheath may be further pulled in the direction it was first drawn so as to make its severed end disappear into the interior of the braided sheath. This is accomplished by continuing to pull on the spacer prior to disconnecting the length of hollow braided sheath from the spacer. Otherwise, it is understood that the length of hollow braided sheath must be disconnected from the spacer, either by being released, as may be accomplished by removing a tap or mechanical fastener used to attached the length of hollow sheath to spacer, or by the spacer having a releasable wire or other loop to which was attached the length of hollow braided sheath, or by the length of hollow braided sheath being cut so the spacer's relevant portion becomes free of the length of hollow braided sheath.

### Continual Flow Production Method

In another embodiment of the present disclosure eyes are spliced at the ends of sections of core rope, resulting in several slings of core rope, i.e. “core rope slings”. Then, using sections of a thinnest twine economically possible to use for any particular purpose, two or more core rope slings are connected one to another by attaching the thinnest possible twine to a first core rope sling at a meeting of a splice braid zone and an open eye of such first core rope sling and attaching the other end of such thinnest possible twine to another core rope sling also at a meeting of the splice braid zone and eye where such eye is most proximal the first core rope sling. The result is a linear element formed of several interconnected core rope slings. The length of the thinnest possible twine between interconnected eyes of subsequent core rope slings is about twice the length of any splice braid zone. Then the removable void spacers are laid alongside at least one of and preferably all of the splice braid zones and retained in place either by taping, other mechanical means, or by hand. Then the in between open eyes portion of the sling formed of a core rope including the splice braid zones having the removable void spacers coupled to themselves are coverbraided using a braiding apparatus where the take up wheel is able to be reversed, as may be a geared, electric, or hydraulically driven take up wheel, and where the braiding apparatus can be paused and restarted at the will of an operator. As a predetermined eye approaches the braid point, the operator pauses the machine, withdraws the eye from the interior zone of the converging braid strands, retains the eye without such interior zone of converging braid strands and re starts the braiding machine. The sheath forming the coverbraid thus also is formed over the sections of thinnest possible twine connecting the eyes of subsequent core rope slings one to another, but not over the eyes. This also is optionally referred to as a hollow braided sheath, as the thin twine within the hollow braided sheath is not a strength member core according to what is understood in the industry to constitute a strength member core. Then, interconnected eyes are affixed to a ram having a hook at each end, each hook grabbing one of the eyes, and the ram's length shortened so as to draw the eyes more tightly together and relieve some of the tension on the section of hollow braided sheath enclosing the thinnest possible twine connecting the eyes of subsequent core rope slings. Then, the braided sheath enclosing the thinnest possible twine, i.e. the hollow braided sheath, is slackened, i.e. made slack, such as by reversing the take up wheel of the braiding apparatus. Next, a predetermined length of the hollow braided sheath is passed through its corresponding open eye, bent back upon itself and attached to the proximal end of the removable void spacer, such as at a point that is about twenty to forty centimeters removed from the point where the hollow braided sheath is nearest the core rope, and there retained, such as by mechanical means or by hand. Then, using mechanical means such as pneumatic or hydraulic retractable rams, or by hand, the removable void spacer is withdrawn (removed) from the portion of coverbraided sheath enclosing it and in a direction that draws at least portions of the attached portion of hollow braided sheath into the braided sheath encompassing the core rope and/or into both the braided sheath encompassing the core rope as well as the core rope itself, depending upon what position was selected for coupling the void spacer to the core rope, so that as a result the hollow braided sheath is doubled over itself and pulled as in a “hairpin” shape, or a “bent double” shape, into a space in between the core rope and the braided sheath, and/or interior the braided sheath as well as interior at least portions of the core rope. That is, the portion of the hollow braided sheath thus comes to occupy a space within the braided sheath encompassing the core rope that previously was occupied by the removable void spacer (i.e. the “object” or “elongate object”).

By loading the linear element formed of several interconnected core rope slings onto a spool, and using such spool as a feed out spool for the braiding machine in conjunction with a feed out wheel, and taking up the interconnected linear elements ultimately over the reversible take up wheel and onto a take up spool, a space in the production line is able to be made to enact the operations of withdrawing the removable void spacers and associated actions, thereby permitting a continuous flow production process.

When the coverbraid is being formed about the splice braid zones the braid angle is adjusted using well known methods for adjusting braid angles with braiding machines so as to ensure that none of the core rope sling's material is visible to the unaided eye through the completed coverbraided sheath. Similarly for the coverbraided sheath over any portion of the core ropes.

### Detailed Step by Step Continual Flow Production Method

Step One: a predetermined length of strength member core is selected (the predetermined length of strength member core also hereinafter referred to as the “core rope”). The core rope preferably is a hollow braided rope. The core rope may have no impregnation material, or may have less than 55% by weight of the maximum amount of any type of impregnation material that it is capable of absorbing, or it may be fully impregnated.

Step Two: an eye is spliced at one end of the length of the core rope, and preferably an eye is spliced at both ends of the length of the core rope, forming a core rope sling. The preferred splice method is to insert the cut end of the core rope into the hollow body of the hollow braided core rope by opening up the braid of the core rope and passing the cut end and the part of the core rope intended to form the inserted portion of core rope forming part of the splice braid zone into the body of the core rope intended to form the external portion of the core rope forming part of the splice braid zone, and then either leaving the cut end of the core rope enclosed within the hollow body of the core rope in the intended splice braid zone or pulling the cut end of the core rope out of the body of the core rope at a point that is at an end of the splice braid zone that is farthest from the eye formed by this process.

Step Three: several core rope slings are attached to one another in order to form a linear element formed of a series of such core rope slings. The various core rope slings are attached to one another to form such linear element by connecting subsequent (and/or intended to be subsequent) core rope slings eye to eye with sections of twine, the twine forming such sections of twine hereinafter also known as “connecting twine”. An intermediate length of connecting twine is left in between the interconnected eyes of each subsequent core rope sling so that such intermediate length of connecting twine is about from twenty centimeters to two hundred centimeters in length, or even more, depending upon the ultimate length of the splice braid zone to be coverbraided. This intermediate length of connecting twine equals approximately double the length of any core rope sling's splice braid zone, or is even about double such length plus an additional five to twenty centimeters.

Step Four: the interconnected core rope slings are wound upon a reel and/or spool that shall be used with or in conjunction with a feed out spool and/or a feed out wheel of a braiding machine that is conventional in that it is designed and configured to form braided sheaths about lengths of rope and/or other linear elements, but is novel in that the take up wheel of the braiding machine is reversible. Care is taken to impart minimal and preferably no rotation to the core rope slings so as to avoid imparting torque to the final finished product. In all cases care is taken to ensure that the core rope slings remain torque free, i.e. lacking a tendency to rotate about their longitudinal axis when tension is applied to the core rope sling and/or to the finished product.

Step Five: a length of twine is passed over the take up wheel and affixed to the take up spool at one end, such length of twine hereinafter also known as the “take up twine”. At another location on the length of take up twine that corresponds to a location intended for the braid point of the various strands, i.e. the strands forming the braided sheath, also are attached to the take up twine. Care is taken to ensure that sufficient length of the take up twine remains upstream of the braid point to permit future knotting and connecting as is described further below, and that such upstream portion of the take up twine is retained outside of the converging braid strands in order to preclude it becoming covered by or enclosed within a hollow braided sheath that is intended to be formed, such withdrawn portion of the take up twine also to be known hereinafter as the “withdrawn portion of take up twine”.

Step Six: the operation of the braiding machine is started causing a hollow braided sheath formed of the strands and any helixing strand to be formed, if one is to be formed, such as when forming a helix rope sling with the process of the present disclosure.

Step Seven: after a predetermined length of the hollow braided sheath is formed, such predetermined length corresponding to about twice the length of the splice braid zone of any eye of any core rope sling being used as a strength member core, plus an additional about ten to twenty centimeters to be used for future steps, the braiding machines operations are paused.

Step Eight: an eye of a first core rope sling that also is an eye forming the distal end of the linear element formed of several interconnected core rope slings and at least a corresponding splice braid zone of the same first core rope sling's eye are inserted into the interior zone of the converging strands forming the hollow braided sheath, and then the eye is withdrawn from within the interior zone of the converging strands forming the hollow braided sheath by passing it through the converging strands forming the hollow braided sheath proximal where such strands enter the braid point.

Step Nine: the withdrawn eye is extended and collapsed, i.e. not opened, and is laid alongside the section of hollow braided sheath formed as a result of the above steps so that the base of the eye, i.e. that portion of the open eye most proximal the splice braid zone, is near the braid point, and the furthest portion of the eye from the base of the eye is further downstream from the braid point.

Step Ten: The action of the braiding machine is started briefly so as to make preferably one wrap, and up to two, three or four wraps of the strands forming the braided sheath about the splice braid zone adjacent the withdrawn eye, then the action of the braiding machine is again paused.

Step Eleven: The withdrawn portion of take up twine is passed through the withdrawn eye of the first core rope sling and knotted back on itself so as to affix the withdrawn eye of the first core rope sling to the withdrawn portion of take up twine, thus attaching the withdrawn eye to the take up wheel thereby allowing to impart traction to the withdrawn eye and thus to the entire core rope sling and any other core rope slings connected to it.

Step Twelve: the hollow braided sheath is severed just upstream of the point where the withdrawn length of twine attaches to the hollow braided sheath.

Step Thirteen: While the braiding action of the braiding machine is retained as paused, the take up spool is energized so as to advance downstream the hollow braided sheath and the braid point, thus tightening the withdrawn portion of take up twine connecting the hollow braided sheath and the withdrawn eye.

Step Fourteen: the upstream severed length of hollow braided sheath is now bent back (i.e. “doubled back”) and passed through the withdrawn eye and then passed into the interior zone of the converging strands forming the hollow braided sheath and then laid alongside the splice braid zone corresponding to the withdrawn eye.

Step Fifteen: the take up wheel is now, if necessary, reversed from its take up direction to a pay-out direction so as to cause the braid tension to become reduced and also so as to cause the braid angle to become more obtuse, until the braid angle is nearer to eighty-nine degrees than it is to seventy degrees when measured between the braid ring and a converging strand used in forming the hollow braided sheath, with a braid angle of about eighty to eighty-seven degrees being also useful, with the result that the core rope sling's material is not visible to an unaided eye after the braided sheath has been formed about the splice braid zone of the core rope sling.

Step Sixteen: the action of the braiding machine is then commenced again, including that the take up spool again commences to rotate in a “take up” direction, causing the braided sheath to form about the splice braid zone corresponding to the withdrawn eye.

Step Seventeen: when the braid point is proximal the point of the splice braid zone that is furthest from the withdrawn eye, the action of the braiding machine is again paused.

Step Eighteen: the take up spool is advanced while the action of the braiding machine remains paused, so as to increase the braid tension and also so as to create a less obtuse (i.e. more acute) braid angle, with the result that the core rope sling's material is not visible after the braided sheath has been formed about a portion of the core rope sling not having a splice braid zone.

Step Nineteen: the action of the braiding machine is again started and continued to operate so as to cause the braided sheath to form about the length of core rope sling up to the point that a portion of the next splice braid zone arrives at the braid point.

Step Twenty: the action of the braiding machine is again paused, and the take up spool is again reversed, again reducing the braid tension and again causing the braid angle to become more obtuse, again so as to achieve the result that no portion of the material forming the core rope sling is visible to the unaided eye after the braided sheath has been formed about the splice braid zone of the core rope sling.

Step Twenty-One: a “removable void spacer” is provided. A preferable removable void spacer is formed of a hollow steel tube such as a hollow steel pipe having a steel eye welded at one end of the pipe and having a high quality steel cable of suitable diameter doubled over and inserted into the other end of the steel pipe and held in place by solidifying a molten bead weld inside the end of the pipe. The result of such a construction method for a removable void spacer is a removable void spacer designed and configured so as to result in a hollow steel pipe having a loop of high grade steel wire protruding at one end and having a steel eye affixed to its other end, such as may be a link of steel chain welded to such other end of the hollow steel pipe. Such preferable removable void spacer shall be known as “the preferred removable void spacer”.

Step Twenty-Two: a preferred void spacer is situated alongside the splice braid zone that is most proximal the braid point in such a fashion that the steel eye of the preferred void spacer as well as some length of the steel pipe of the preferred void spacer is lying alongside the braided sheath while the majority of the preferred void spacer's steel pipe is lying alongside the core rope sling's still uncovered splice braid zone in such a fashion that the steel pipe ends and the steel wire loop commences where the exposed splice braid zone meets its open spliced eye. To effectively so position the preferred void spacer, it is needed to first insert the preferred void spacer into the interior zone of the converging braid strands, and then to withdraw that portion of it that is to lie alongside the braided sheath by passing the steel eye of the preferred void spacer through the converging strands forming the braided sheath proximal where such strands enter the braid point.

Step Twenty-Three: the take up wheel is now again reversed from its take up direction to rather a pay out direction so as to cause the braid tension to become reduced and also so as to cause the braid angle to become more obtuse, until the braid angle is nearer to eighty-nine degrees than it is to seventy degrees when measured between the braid ring and a converging strand used in forming the hollow braided sheath, with a braid angle of about eighty to eighty-seven degrees being also useful, with the result that the core rope sling's material is not visible to an unaided eye after the braided sheath has been formed about the splice braid zone of the core rope sling.

Step Twenty-Four: the action of the braiding machine is then commenced again, causing the braided sheath to form about the splice braid zone.

Step Twenty-Five: the action of the braiding machine is again commenced including that the take up spool again commences to rotate in a “take up” direction until the braided sheath is formed to about the location where the splice braid zone meets its open eye.

Step Twenty-Six: The braiding machine's operations are again paused.

Step Twenty-Seven: a connecting line connecting the two open eyes most proximal the braiding point is severed, and that open eye having its splice braid already covered by the braided sheath is withdrawn from within the interior zone of the converging braid strands in a similar manner as described supra for withdrawing an open eye from within such interior zone of converging braid strands, and the other eye is retained on a hook that is provided underneath the braid point.

Step Twenty-Eight: The braiding machines action is again started so as to cause more hollow braided sheath to be formed downstream of the withdrawn eye, the length of hollow braided sheath to be formed again corresponding to about two times the length of the splice braid zones present on the core rope slings plus an additional about twenty centimeters of length.

Step Twenty-Nine: when about half the intended overall length of the hollow braided sheath being formed in the above step is completely formed, the braiding machine is again paused and a section of twine is attached at the braid point to the strands forming the hollow braided sheath, said section of twine being about twice the length of a splice braid zone to be coverbraided, and said section of twine being retained outside of the converging braid strands. This section of twine is hereinafter also known as the “next eye connecting twine”.

Step Thirty: the braiding machine is again started and operated until the intended length of the hollow braided sheath is formed.

Step Thirty-One: The eye of the core rope sling that has been retained on a hook underneath the braid point is now inserted into the interior zone of the converging braid strands, and then withdrawing from such interior zone of converging braid strands in the fashion as described above for withdrawing eyes from such interior zone of converging braid strands, while the splice braid zone corresponding to this eye is retained within the interior zone of the converging braid strands so that it can be coverbraided. This eye is then attached to the next eye connecting twine.

Step Thirty-Two: While the braiding action of the braiding machine is retained as paused, the take up spool is energized so as to advance downstream the hollow braided sheath and the braid point, thus tightening the eye connecting twine that connects the hollow braided sheath and the withdrawn eye.

Step Thirty-Three: the length of hollow braided sheath is not pulled through the open eye, and next:

Step Thirty-Four: the length of hollow braided sheath is not attached, at about midpoint its length, to the open portion of the steel wire loop forming the terminal end of that void spacer nearest the end of that eye already having had its splice braid zone coverbraided. The portion of the hollow braided sheath is in the shape of a “hair pin bend” that itself is again bend back, that is doubled over the steel wire loop, and held in place by hand by being squeezed together with the other portion of the hollow braided sheath near the steel wire loop. The severed ends may be wrapped tightly with tape and then cut into a spiked, tapered shape to facilitate such insertion and retention.

Step Thirty-Five: the preferred void spacer is pulled out (i.e. is withdrawn and/or removed) from between the sheath and the core rope, in a direction that draws the doubled over portion of the hollow braided sheath into within the braided sheath and causes it to occupy a position between the braided sheath and the core rope's splice braid zone that previously was occupied by the preferred void spacer. Next, the length of hollow braided sheath is severed, preferably near its disappearance into the interior of the braided sheath. Optionally, the preferred void spacer is further pulled upon so as to draw more the hollow braided sheath into the interior of the braided sheath, thereby hiding from view the severed end of the hollow braided sheath.

A hydraulic or pneumatic ram is useful for so withdrawing the preferred void spacer. Optionally, a lubricant may be added to assist in drawing the severed hollow braided sheath into position. Such lubricant also may be used to lubricate the preferred void spacer prior to its use. Such lubricant is especially useful should the braided sheath be formed of highly inelastic materials such as UHMWPE and others. This step may be made either when the portion of splice braid zone with the preferred void spacer is upstream of or downstream of the take up wheel, so long as tension is maintained on the coverbraided core rope sling so as to permit withdrawing the preferred void spacer. The take up wheel may be cushioned or padded to permit the preferred void spacer to pass over it under tension without damaging either the product being formed of the machinery.

To produce further and subsequent spliced eye coverbraided rope slings of the present disclosure, the actions, steps, methods and processes described in Steps Fourteen and onward are now repeated in the order and sequence as described hereinabove in order to produce the next spliced eye helix rope sling of the present disclosure. Then, the Steps Fourteen and onward may again be repeated, each time they are repeated another sling of the present disclosure being formed, until the linear element formed from the interconnected core rope slings is consumed. Then, Steps One and onward are repeated in order to form more helix rope slings of the present disclosure as desired.

Preferably, prior to splicing the eyes into any section of core rope so as to form a core rope sling, a very abrasion resistant, very durable sheath is slid upon the core rope and maintained in a region corresponding to any intended open eye to be formed, thereby resulting in a sheathed eye. The best construction for such a sheath is a hollow braided construction that has been made rigid by use adhesives and by forming a hollow braid of very tight wraps about a rod or rope that is then removed from such hollow braid where such rope or rope has a diameter that is sufficiently larger than the diameter of the core rope to be sheathed so that it is not difficult to pass the body of the core rope into the sheath. The rigidity imparted to any eye by such sheath greatly facilitates handling of the eyes in the production process of the present disclosure.

It is important that the braid angle and the elasticity of fibers forming both the braided sheath and forming the strength member of either the helix rope or of the spliced eye helix rope sling of the present disclosure, or of any other rope or of any other sling of the present disclosure, are selected so that the braided sheath and the strength member core or their equivalents both experience total failure at the same elongation of the final produced helix rope or its counterparts. For example, when less elastic fibers form the braided sheath, and more elastic fibers form the strength member core rope, the strength member core rope's strands are of a less obtuse braid angle than are the strands forming the braided sheath.

Preferably, prior to splicing any eyes into the alternative strength member core, the same very abrasion resistant, very durable sheath is constructed, configured and used as mentioned above to both stiffen and protect the resultant eyes.

### INDUSTRIAL APPLICABILITY

The method of the present disclosure for forming slings of coverbraided rope or for forming spliced eyes into portions of coverbraided rope can be used to form a sling of other coverbraided rope, including forming slings of a type of coverbraided rope know as a helix rope as well as all types of ropes and lines mentioned supra, and to form a spliced eye into portions of other coverbraided rope, including helix rope as well as all types of ropes and lines mentioned supra. The slings of coverbraided rope thus formed, or the spliced eye included in a portion of coverbraided rope thus formed, can be used to form portions of a trawl, a towing warp using spliced eyes, such as a seismic towing warp, a mooring or anchoring rope, a crane rope, and deep sea winch line and any and all types of ropes and lines mentioned supra or any other.

Although the present disclosure has been described in terms of the presently preferred embodiment, it is to be understood that such disclosure is purely illustrative and is not to be interpreted as limiting. Consequently, without departing from the spirit and scope of the disclosure, various alterations, modifications and/or alternative applications of the disclosure shall, no doubt, be suggested to those skilled in the art upon having read the preceding disclosure. Accordingly, it is intended that the following claims be interpreted as encompassing all alterations, modifications or alternative applications as fall within the true spirit and scope of the disclosure.

1. A process for producing a sling including a coverbraid and having an eye at one or both ends, the process comprising steps of:
a. providing a sling formed of a length of core rope and having an eye at one or both ends;
b. situating a spacer that preferably is an elongate object at a predetermined location that is a location positioned alongside a portion of the length of core rope;
c. forming a braided sheath about the length of core rope while not covering an eye with the same braided sheath, and while covering at least portions of the spacer with at least portions of the braided sheath;
d. withdrawing from within the interior zone of converging strands forming the braided sheath an eye of the sling;
e. retaining the withdrawn eye without the interior zone of the converging braid strands;
f. forming with the braiding machine a length of hollow braided sheath;
g. attaching a portion of the length of hollow braided sheath to the spacer;
h. removing the spacer from between the braided sheath and the core rope in a direction that draws the portion of the length of hollow braided sheath into the braided sheath and causes it to occupy a position that previously was occupied by the spacer; and
i. severing the length of hollow braided sheath; whereby a sling including a coverbraided sheath is economically produced.

2. The process of claim 1 further comprising steps of, prior to step (b), attaching end to end several slings formed of core rope so as to form a series of slings connected end-to-end, and then carrying out for each sling the subsequent steps.

3. The process of claim 1 wherein the step of situating the spacer at a predetermined location that is a location positioned alongside a portion of the length of core rope further comprises selecting for the location a location passing through portions of the length of core rope.

4. The process of claim 1 wherein the step of forming a braided sheath about the length of core rope while not covering an eye with the same braided sheath, and while covering at least portions of the spacer with at least portions of the braided sheath, further comprises forming the braided sheath with a braiding machine.

5. (canceled)

6. The process of claim 2 wherein the step of situating the spacer at a predetermined location that is a location positioned alongside a portion of the length of core rope further comprises selecting for the location a location passing through portions of the length of core rope.

7. The process of claim 2 wherein the step of forming a braided sheath about the length of core rope while not covering an eye with the same braided sheath, and while covering at least portions of the spacer with at least portions of the braided sheath, further comprises forming the braided sheath with a braiding machine.

8. The process of claim 3 wherein the step of forming a braided sheath about the length of core rope while not covering an eye with the same braided sheath, and while covering at least portions of the spacer with at least portions of the braided sheath, further comprises forming the braided sheath with a braiding machine.

9. The process of claim 4 wherein the step of forming a braided sheath about the length of core rope while not covering an eye with the same braided sheath, and while covering at least portions of the spacer with at least portions of the braided sheath, further comprises forming the braided sheath with a braiding machine.

10. The process of claim 1 forming slings in portions of a trawl.

11. The process of claim 2 forming a series of slings in portions of a trawl.

12. The process of claim 3 wherein positioning of the spacer alongside a portion of the length of core rope occurs during assembly of a trawl.

13. The process of claim 4 wherein the braided sheath formed by the braiding machine is part of a trawl.

14. The process of claim 6 wherein positioning of the spacer alongside a portion of the length of core rope occurs during assembly of a trawl.

15. The process of claim 7 wherein the braided sheath formed by the braiding machine is part of a trawl.

16. The process of claim 8 wherein the braided sheath formed by the braiding machine is part of a trawl.

17. The process of claim 9 wherein the braided sheath formed by the braiding machine is part of a trawl.
